(19) United States
(12) Patent Application Publication
(10) Pub. No.: US 2011/0184668 A1
(43) Pub. Date: Jul. 28, 2011

(54) Apparatus and method for level measuring in a tank with flexible walls

(75) Inventors: Leszek JUCHNIEWICZ, Wohltorf (DE); Dirk WILSHUSEN, Hamburg (DE); Nils WINKLER, Hamubrg (DE)

(73) Assignee: HANSACONSULT INGENIEURGESELLSCHAFT MBH, Reinbek (DE)

(21) Appl. No.: 12/964,329

(22) Filed: Dec. 9, 2010

(30) Foreign Application Priority Data
Jan. 23, 2010 (DE) 10 2010 005 540.9

(51) Int. Cl. G01F 1/00; G01F 23/284; G01F 23/00; G06F 19/00; G06F 15/00

(52) U.S. Cl. 702/45; 73/290 V; 73/295; 702/55; 702/130; 702/137

(57) ABSTRACT

An apparatus for level measuring in a flexible tank with a level sensor for non-contact detection of the level of the liquid in the tank, which detects the surface of the liquid across a flexible wall of the tank, and means for holding the level sensor in a position above the flexible wall of the tank.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to an apparatus and to a method for level measuring in a flexible tank.

Such flexible tanks also designated as bladder tanks. The tank clothing consists of a rubber tissue or of a plastics tissue. Flexible tanks can be easily installed, dismounted and brought to another location of utilisation. Therefore, they are used in particular in case that a liquid must be stored temporarily at a location. As a consequence, they are often used for military, humanitarian or agricultural purposes for storing fuels (like diesel oil, kerosene or gasoline), (drinking-) water or of agricultural products (for instance vegetable oil) or agricultural active agents (like plant protection agents). Bladder tanks are offered with different filling volumes. In particular, there are such ones with filling volumes in the range of 1 000 to 1 000 000 litres.

Up to now, the actual filling volume of a flexible tank is determined by way of manual dipping devices. For this purpose, the filling height of the medium in the tank above a reference plane, normally the bottom level, is detected by measurement and than converted by way of bearing charts which indicate the filling volume for different levels. Bearing charts (called also “tank charts) are determined by the manufacturers of flexible tanks, normally with the presumption that the tanks rest on a plane, horizontal area. However, in practice flexible tanks are installed in the open ground, which is often uneven or has a slope, respectively. This negatively affects the accuracy of the determination of filling volumes by way of bearing charts.

The detection of the level takes place either by position finding of the liquid level with a dip stick, or by acquiring the level of the upper container edge of the flexible tank by way of a levelling lath.

The method for determining the filling height by way of a dip stick is performed analogously to the determination of the oil level in a vehicle motor by way of an oil measuring stick. The dip stick is dipped into the liquid up to the reference plane and pulled out, and then the level is read out by means of the surface of the dip stick that is wetted by the medium. At closed bladder tanks, an opening in the clothing of the bladder tank is necessary for this method, which can normally be accessed only by entering the interior of the tank.

In the measurement of the filling height by way of a levelling lath, the same is put onto the reference level outside the bladder tank, and the filling height is read out on the levelling lath by way of a horizontal aiming beam that is adjusted to the upper edge of the container.

Both methods have in common that they strongly depend on the care taken in the measurements, and other external influences. For instance, by the necessary entering of the tank clothing when the position is to be found in a closed bladder tank, wave movements in the medium might occur in the tank, which negatively influence the measuring result. When the filling height is determined by way of a levelling lath, measurement errors can be caused by air in the tank. Thus, the measurement results are reproducible only within a relatively large field of tolerance. Moreover, both methods yield only a snapshot at the moment of the measurements. The measurements themselves are sumptuous with respect to time and personnel. The measurement results must be manually detected and processed. Also, thermal influences which have an immediate effect on the volume of the medium can be detected not at all or only to a very limited extent.

Starting from this, the present invention is based on an objective to provide a method for level measuring in flexible tanks which yields more accurate results, is less time- and personnel consuming and permits a continuous level measurement.

The apparatus of the present invention for level measuring in a flexible tank has a level sensor for non-contact detection of the level of the liquid in the tank, which detects the surface of the liquid across a flexible wall of the tank, and means for holding the level sensor in a position above the flexible wall of the tank.

In the method for level measuring in a flexible tank according to the present invention, the level of the liquid in the tank is detected from out a certain position above the tank across a flexible wall of the tank by way of a level sensor for non-contact detection of a liquid level.

According to the present invention, the level of the liquid in the flexible tank is non-contact detected across the flexible wall of the tank by way of a level sensor. For this purpose, the level sensor is placed above the tank on a certain location. The level sensor can measure the height of the liquid column in the tank, or respectively the liquid level in the tank above a zero level. The zero level can be determined at empty tank in that the level sensor detects the bottom on which the tank rests. The respective distance of the level sensor from the liquid surface is detected by the level sensor. The level in the tank can be determined with the aid of the distance of the zero level from the level sensor. The determined level may be documented or given out. Further, like in the conventional manual measurement, the associated filling volume can be determined and documented or given out from the determined level with the aid of a tank chart. The determined levels and filling volumes can be used for controlling the delivery of liquid from tanks and for filling up tanks. The level measurement according to the present invention can be performed automatically without having to employ personnel and without particular expense of time. It can be performed repeatedly at different points in time or in short intervals in time, quasi continuously or continuously. Suitable sensors, which permit measurement of the level across the flexible wall of a bladder tank in a non-contact manner, are available in the form of radar sensors in particular. Up to now, radar sensors had been used only for level measuring in steel tanks, wherein they have been inserted into the tank through an opening. For the first time, according to the present invention, the measurement of the level takes place across the flexible wall of a bladder tank.

According to one embodiment, the level sensor is placed as centrally as possible above the longitudinal axis of the bladder tank, via a cross bar- or a cantilever arm construction.

According to a further embodiment, in addition to the filling height, the temperature of the medium in the tank is detected also, at one or plural measuring points by way of at least one temperature sensor, in order to compensate for volume changes due to thermal influences. For this purpose, a temperature measurement chain may be installed in the tank, which can be connected to the level sensor via a computer-assisted analysing procedure.

According to one embodiment, all the detected data are acquired and processed by way of an electronic data processing unit. In principle, when doing this, the determination of the filling volume can be performed by means of the bearing charts that are provided by the manufacturer. Bearing charts can be deposited in the computer for automatic determination of the filling volume.

Even higher accuracies can be achieved with the level measuring of the present invention if according to one embodiment, an installation of the measuring system is performed after the set-up of the tank. In order to do this, the zero level is measured at empty tank by way of the level sensor, and set as the reference plane. Thereafter, the tank is filled continuously via an accurate counter device or flow meter device, respectively. The counter device may be associated to the level sensor and the temperature measurement chain via software. During filling, the amount of the liquid filled in and being temperature compensated and the corresponding level are correlated with each other, and a bearing chart is established. By doing so, it can be compensated for position tolerances of the bladder tank or position errors, respectively. The bearing chart is deposited in the computer as a reference chart for the determination of filling volumes when the tank is being operated.

Radar sensors that are suitable for the use in the apparatus for level measuring of the present invention are for instance Saab Tank-Radar Rex® and Saab Tank-Radar Pro®. For Saab Tank-Radar Rex®, the display unit RDU 40 is available from the company Emerson Process Management, and for Saab Tank-Radar Pro® the display unit 2210 DU. Moreover, the company Emerson Process Management offers a suitable radar sensor under the designation “Radar-Messumformer für Füllstand Serie 5600”. Further, the company Emerson Process Management offers suitable temperature sensors under the designation “Multiple spot thermometers—MST”. These are temperature measuring chains which have plural temperature probes on a flexible cable. The temperature measuring chains can be hung into the tank via an opening, and they detect the temperature of a liquid that is filled in at different levels. The different measured values can be used to calculate a mean value.

### BRIEF DESCRIPTION OF THE SEVERAL VIEWS OF THE DRAWINGS

In the following, the present invention is explained in more detail by means of the attached drawings of examples of its realisation. In the drawings show:

FIG. 1 a radar sensor for detecting the level on a telescopic cantilever arm above a bladder tank, in a vertical section;

FIG. 2 a radar sensor for detecting the level on a telescopic, fixedly foundation based cross bar above a bladder tank, in a vertical section;

FIG. 3 a radar sensor for detecting the level on a telescopic, mobile cross bar above a bladder tank, in a vertical section;

FIG. 4 a radar sensor for detecting the level on a rigid cross bar above a bladder tank, in a vertical section;

FIG. 5 a principle sketch of a tank storage facility with bladder tanks, foldable tank with radar sensors and temperature sensors in a rough scheme.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

In the following explanation of different examples of realisation, coincident features are provided with the same reference numerals.

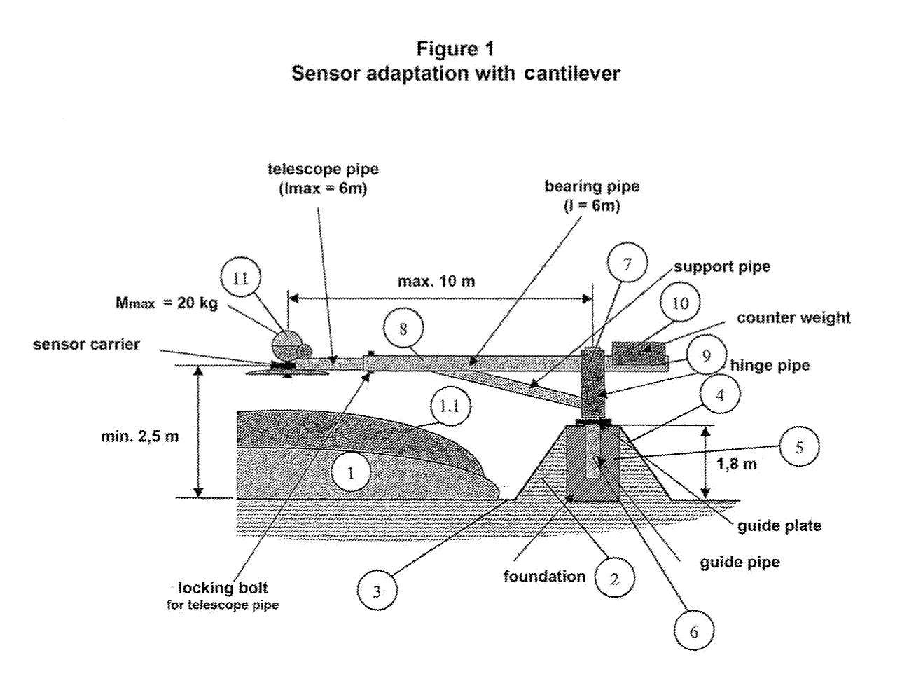

According to FIG. 1, a bladder tank 1 having a flexible wall 1.1 is stored in an excavation 2, which has a liquid-tight cladding 3. In the FIGS. 1 to 4, the bladder tank 1 is in each case drawn in a darker tone in the maximally filled condition, and in a lighter tone in a partially emptied condition.

On an earth wall 4 laterally limiting the excavation 2, a vertical support post 7 is pivotally mounted in a guide pipe 6 in a foundation 5. The support post 7 bears a horizontal, telescopic gibbet- or cantilever arm 8. The telescopic cantilever arm 8 has a short extension 9 on the other side of the support post 7, on which a counterweight 10 is mounted. On its free end, the cantilever arm 8 carries a radar sensor 11, which is directed vertically towards the downside. The radar sensor 11 is disposed above the bladder tank 1. In this, the cantilever arm 8 is pivoted and telescoped such that the radar sensor 11 is located on a suitable location, for instance above the apex of the bladder tank 1.

By way of the radar sensor 11, the level in the bladder tank 1 can be monitored continuously. This arrangement permits an accurate adjustment of the radar sensor 11 towards the central region of the bladder tank 1. Moreover, it can be used in order to monitor the level in plural bladder tanks 1 that are arranged side by side. For this purpose, the radar sensor 11 can be pivoted above the measurement region of another bladder tank 1 by pivoting and telescoping the cantilever arm 8.

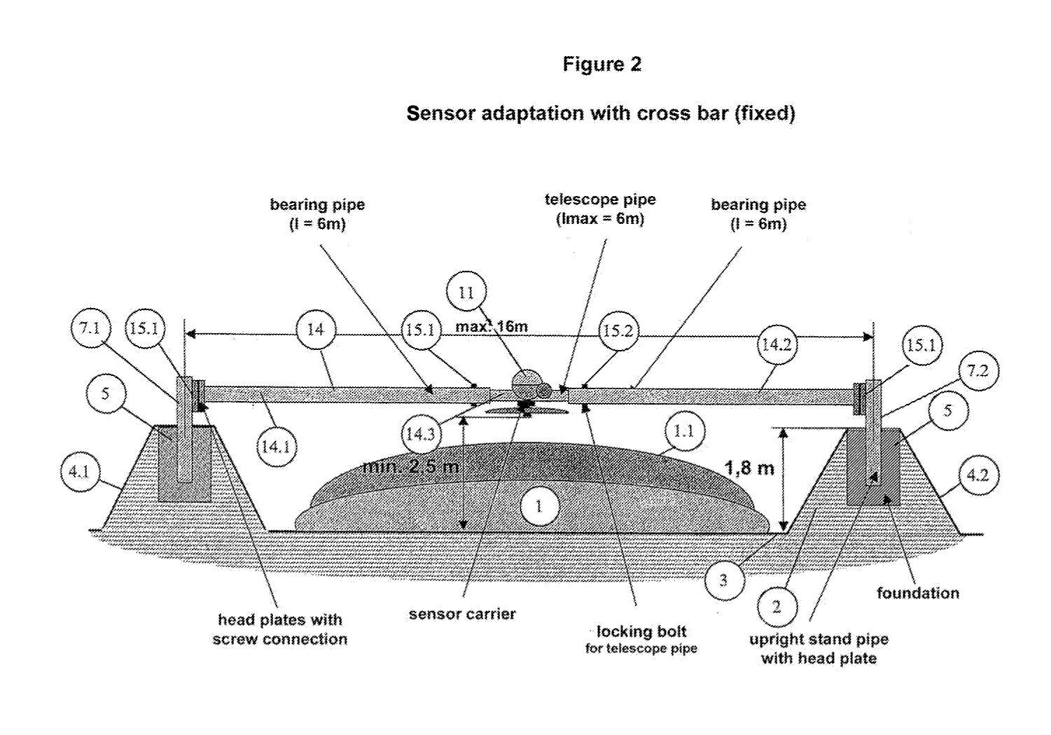

According to FIG. 2, a bladder tank 1 is stored in an excavation 2, one support post 7.1, 7.2 being mounted on each of two opposing earth walls 4.1, 4.2. Both support posts are fixedly encased in a foundation 5 with concrete.

A telescopic cross bar 14 is disposed between the two support posts 7.1, 7.2. It comprises two pipe-shaped outer cross bar parts 14.1, 14.2, which are fixedly connected to head plates 15.1, 15. 2 on their outer ends, the head plates 15.1, 15.2 being connected to the stationary support post 7.1 by a screw connection.

A central cross bar part 14.3 in the form of a telescope pipe is inserted into the inner ends of the pipe-shaped cross bar parts 14.1, 14.2. The central cross bar part 14.3 bears a radar sensor 11. By telescoping the central cross bar part 14.3 within the two outer cross bar parts 14.1, 14.2, the radar sensor 11 can be adjusted above the central region of the bladder tank 1. The central cross bar part 14.3 can be secured in this position via locking bolts 15.1, 15.2.

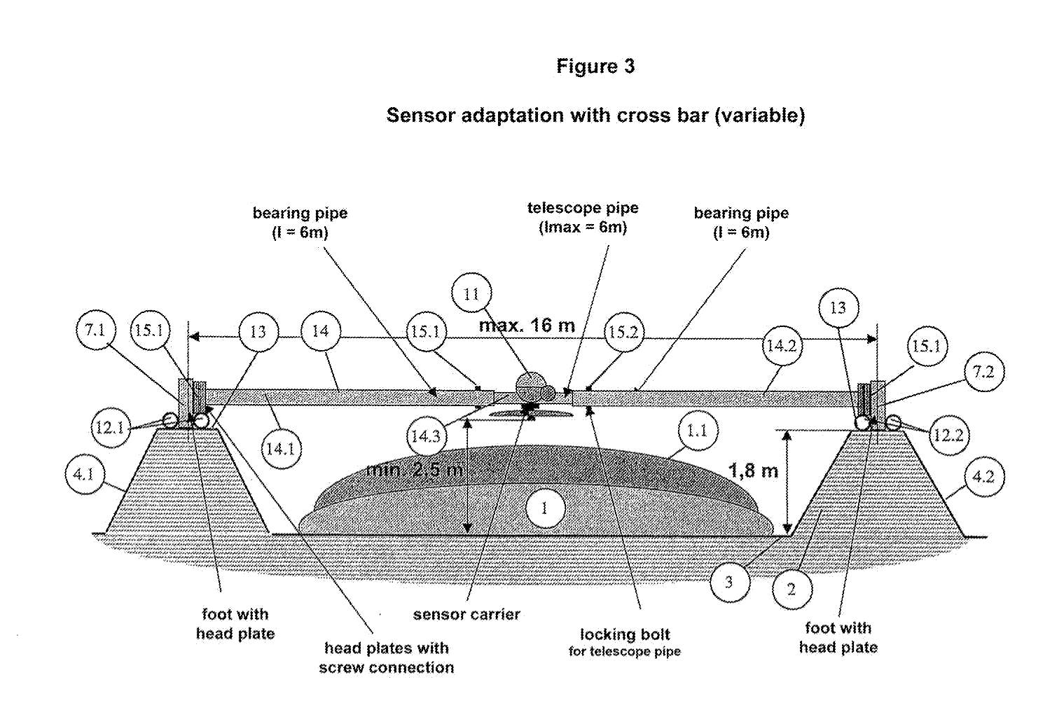

According to FIG. 3, a bladder tank 1 is stored in an excavation 2, one support post 7.1, 7.2 being mounted on each of two opposing earth walls 4.1, 4.2. Both support posts are movably mounted on the crowns 13 of the earth walls 4.1, 4.2.

A telescopic cross bar 14 is disposed between the two support posts 7.1, 7.2. It comprises two pipe-shaped outer cross bar parts 14.1, 14.2, which are fixedly connected to head plates 15.1, 15. 2 on their outer ends, the head plates 15.1, 15.2 being connected to the stationary support post 7.1 by a screw connection.

A central cross bar part 14.3 in the form of a telescope pipe is inserted into the inner ends of the pipe-shaped cross bar parts 14.1, 14.2. The central cross bar part 14.3 bears a radar sensor 11. By telescoping the central cross bar part 14.3 within the two outer cross bar parts 14.1, 14.2, the radar sensor 11 can be adjusted above the central region of the bladder tank 1. The central cross bar part 14.3 can be secured in this position via locking bolts 15.1, 15.2.

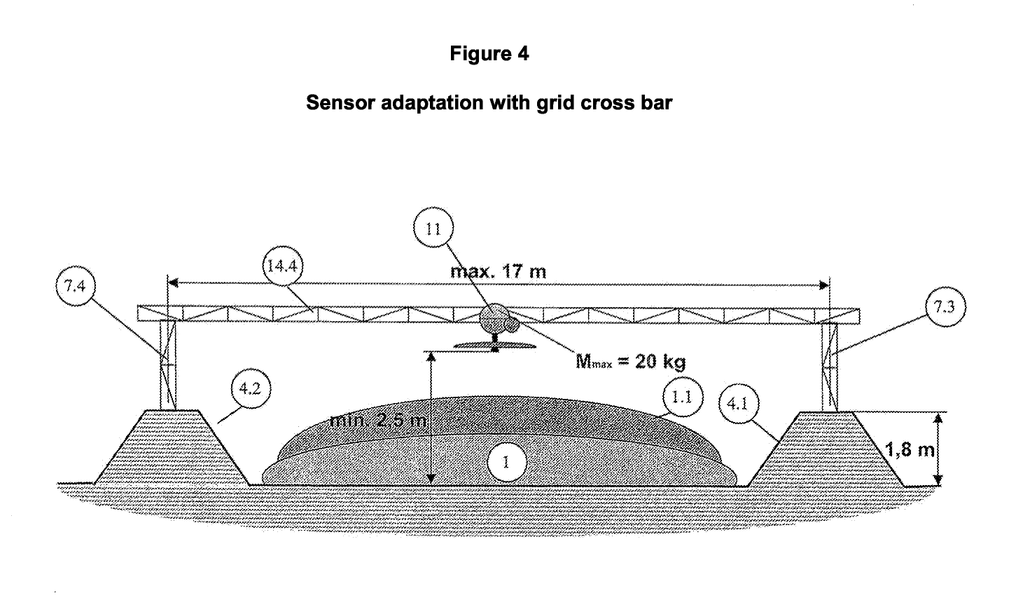

According to FIG. 4, on the earth walls 4.1, 4.2, stationary support posts 7.3, 7.4 are fixedly disposed on opposing sides of a bladder tank 1. A cross bar 14.4 is fixedly mounted above the latter. The support posts 7.3, 7.4 and the cross bar 14.4 are realised as a grid construction. A radar sensor 11 which is vertically directed towards the downside is mounted on the cross bar 14.4 centrally above the bladder tank 1.

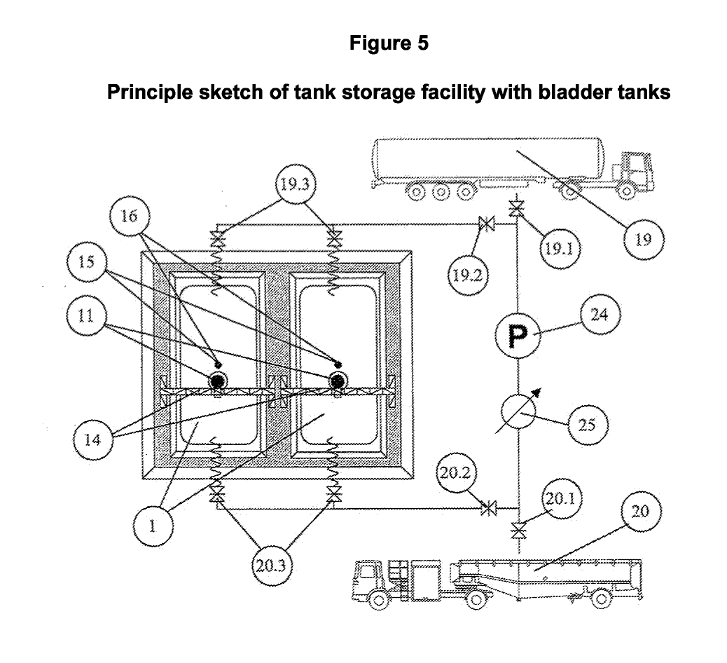

In FIG. 5, radar sensors 11 are fixed above the longitudinal axis of bladder tanks 1 by way of cross bar 14.4 according to FIG. 4. Temperature sensors 16 are hanged into the bladder tank 1 through the ventilation openings 15.

A supplying road tank vehicle 19 is connected to the bladder tanks via a supply valve 19.1, a pump 24, a counter device 25, a distributor valve 20.2 and two parallel tank inlet valves 20.3. Via the tank delivery valves 19.3, the distributor valve 19.2, the pump 24 and the counter device 25, the medium can be optionally pumped via the distributor valve 20.2 and the tank inlet valves 20.3, or delivered into another tank vehicle 20 via the delivery valve 20.1.

In order to fill a bladder tank 1, the valves 19.1 and 20.2 as well as a tank inlet valve 20.3 are opened, and the pump 24 is switched to work. The counter device 25 continuously measures the flow amount, and the radar sensor 11 continuously monitors the filling height, and the temperature of the liquid that has been filled in is continuously monitored by the temperature sensor 16. From these data, an electronic data processing unit connected to the radar sensor 11 and the temperature sensor 16 determines the filling volumes associated to the measured levels. For this purpose, a tank chart is established or a tank function is deposited in the data processing unit.

In order to deliver liquid from a bladder tank 1, the valves 19.1, 20.2 and 20.3 are closed and the corresponding tank delivery valve 19.3 as well as the valves 19.2 and 20.1 are opened. The pump 24 pumps liquid out of the selected bladder tank 1. In doing so, the level is continuously detected via the radar sensor 11, and the temperature of the liquid in the bladder tank 1 is continuously detected via the temperature sensor 16. The electronic data processing unit determines the filling volume present in the respective bladder tank 1 by way of the tank chart or the tank function. The filling volume that was drawn out can be determined by comparing the filling volumes before and after taking out liquid, or with the aid of the volume- or mass flow detected by the counter device 25.

This completes the description of the preferred and alternate embodiments of the invention. Those skilled in the art may recognize other equivalents to the specific embodiment described herein which equivalents are intended to be encompassed by the claims attached hereto.

What is claimed is:

1. An apparatus for level measuring in a flexible tank (1) with a level sensor (11) for non-contact detection of the level of the liquid in the tank (1), which detects the surface of the liquid across a flexible wall (1.1) of the tank, and holding mechanism (7, 8, 14) for holding the level sensor (11) in a position above the flexible wall (1.1) of the tank (1).

2. The apparatus according to claim 1, wherein the level sensor (11) is a radar sensor.

3. An apparatus according to claim 1, wherein the holding mechanism has a cross bar (14) or a cantilever arm (8), on which the level sensor (11) is affixed.

4. An apparatus according to claim 1, wherein the holding mechanism has at least one support post (7), on which the cross bar (14) or the cantilever arm (8) is/are affixed.

5. An apparatus according to claim 1, wherein the holding mechanism (7, 8, 14) positions the level probe (11) above a central region of the tank (1).

6. An apparatus according to claim 1, which has at least one temperature sensor (16) for detecting the temperature of a liquid in the tank (1), which is positioned with the aid of the mechanism for holding the temperature sensor (16) in the tank (1).

7. The apparatus according to claim 6, wherein the temperature sensor (16) is inserted into the tank (1) through an opening (15).

8. An apparatus according to claim 1, wherein the level sensor (11) is connected to an electronic data processing unit which is configured such that by way of a tank chart which comprises filling volumes and the associated levels, or by way of a tank function indicating the filling volumes as a function of the levels, it determines the associated filling volumes from the measured level heights.

9. The apparatus according to claim 8, wherein a flow meter device (25) is arranged in a line for filling the tank (1) and is connected to the electronic data processing unit, and the electronic data processing unit is configured such that when the tank (1) is being filled, it determines the respective filling volumes from flow measurement values and combines the same to a tank chart with the associated levels that were detected by the level sensor (11), and/or determines a tank function from the associated filling volumes and levels.

10. An apparatus according to claim 8, wherein the electronic data processing unit has a memory for data concerning the relation between the temperature and the density of a liquid with which the tank (1) is filled, and is configured such that it determines the density of the liquid in the tank (1) for the temperature of the liquid in the tank (1) detected by the temperature sensor (16), and determines the liquid volume associated to the detected level taking into account the density at the detected temperature of the liquid, and/or determines the filling volume of the liquid associated to the flow quantity detected by the flow meter device (25), taking into account the density of the liquid associated to the detected temperature.

11. An apparatus according to claim 1, wherein the electronic data processing unit is a central data processing unit which is connected to the level sensors (11) and optionally the temperature sensors (16) of plural tanks (1) via a network.

12. A method for level measuring in a flexible tank (1), wherein from out a certain position above the tank (1), the level of the liquid in the tank (1) is detected across a flexible wall (1) of the tank by way of a level sensor (11) for non-contact detection of a liquid level.

13. The method according to claim 12, wherein the level in the tank (1) is non-contact detected by way of radar.

14. A method according to claim 12, wherein the temperature of the liquid in the tank (1) is detected by way of a temperature sensor (16).

15. A method according to claim 12, wherein the filling volumes are determined by way of a tank chart which contains the filling volumes and the associated levels, or by way of a tank function indicating the filling volumes as a function of the levels.

16. A method according to claim 12, wherein the liquid amount supplied to the tank (1) is determined and the filling volume of the tank (1) is determined by way of the determined liquid amount, and a tank chart or a tank function is established by way of the levels determined when the tank (1) is being filled, which are associated to the determined filling volumes.

17. A method according to claim 12, wherein the density of the liquid in the tank (1) is determined for the detected temperatures of the liquid in the tank (1), and the liquid volume associated to the detected level is determined taking into account the density, and/or the filling volume of the liquid associated to the detected flow quantity is determined by way of the density of the liquid in the tank.

18. A method according to claim 12, wherein the levels and optionally the temperatures are detected in plural spatially distributed tanks (1) and are transmitted to a central analysing unit, and the associated filling volumes are determined there.

19. A method according to claim 12, wherein the levels in the tanks (1) are determined at discrete points in time or (quasi) continuously.
